(19) United States
(12) Patent Application Publication
(10) Pub. No.: US 2009/0061101 A1
(43) Pub. Date: Mar. 5, 2009

(54) DUST CONTROL COMPOSITIONS HAVING REDUCED CORROSION AND METHOD OF INHIBITING DUST AND CORROSION

(75) Inventors: John C. Cranfill, Pewee Valley, KY (US); Kenneth D. Burnside, Ft Myers, FL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: AKJ INDUSTRIES, Fort Meyers, FL (US)

(21) Appl. No.: 11/848,966

(22) Filed: Aug. 31, 2007

(51) Int. Cl. C09K 3/22; B05D 1/02; B05D 1/30

(52) U.S. Cl. 427/427.1; 252/88.1; 427/445

(57) ABSTRACT

A method for controlling dust on a surface with limited corrosion comprising forming admixture of xanthan gum in a halide brine solution in an amount effective to inhibit corrosion; and applying the admixture to a surface in an amount effective for dust control.

### FIELD OF THE INVENTION

The present invention relates to corrosion-inhibited dust control compositions. More specifically, the invention is directed to dust-inhibiting salt (brine) concentrates and other solutions containing suspended and/or soluble xanthan gum as a corrosion inhibitor.

### BACKGROUND

Halide brines, comprising one or more dissolved or suspended salts in water, usually halide salts, especially chloride salts, particularly sodium chloride and other alkali metal and alkaline earth metal salts such as calcium chloride and magnesium chlorides, are used extensively for inhibiting dust on a variety of surfaces including such uses as dust control of roadways, paved areas, bridges and the like as well as for inhibiting dust on surfaces of bulk materials, such as coal and minerals. They are also used for dust control, especially during dry weather during the handling and transportation of dust-producing bulk materials, such as coal.

Aqueous solutions of these halides are known to corrode metals and cause scaling or surface damage to concrete. For example, heavy use of road deicers can result in serious damage to steel, particularly autos and other vehicles, as well as rapid deterioration of steel reinforcing rods in poured concrete roadways and bridges. The halides used for dust control of bulk materials such as coal or other minerals often cause corrosive deterioration of the materials-handling equipment, rail cars and other container carriers.

The prior art has used a variety of materials in halide brines and fire retardant compositions to inhibit the corrosion of metals contacted with the aqueous salt solutions, as described below.

U.S. 2002/0096668 A1 describes a corrosion-inhibited fire retardant composition containing a corrosion inhibiting compound selected from a group of compounds including azoles, insoluble ferric pyrophosphate, soluble ferric pyrophosphate, ferrous oxalate, ferric citrate, ferrous sulfate, ferric ammonium citrate, soluble ferric orthophosphate, insoluble ferric orthophosphate, ferric ammonium oxalate, ferric ammonium sulfate, ferric bromide, ferric sodium oxalate, ferric stearate, ferric sulfate, ferrous acetate, ferrous ammonium sulfate, ferrous bromide, ferrous gluconate, ferrous iodide, ferric acetate, ferric fluoroborate, ferric hydroxide, ferric oleate, ferrous fumarate, ferrous oxide, ferric lactate, ferric resinate and any combination thereof.

U.S. Pat. No. 4,358,389 describes de-icing compositions containing corrosion inhibitors selected from the group consisting of inorganic alkali metal salts, preferably the potassium or sodium salts of carbonic acid, of phosphorous acid, of phosphoric acid and of silicic acid; alkali metal salts of fatty acids, preferably the potassium or sodium salt of lauric acid, palmitic acid, stearic acid, benzoic acid and oleic acid; monoalkylamines and dialkylamines—optionally alkoxylated—and salts thereof with a mineral acid or a fatty acid, preferably butylamine, hexylamine, octylamine, isononylamine, oleylamine, di-propylamine and di-butylamine; alkanolamines—optionally alkoxylated—and salts thereof with a fatty acid, preferably mono-, di- and tri-ethanolamines, mono-, di- and tri-propanolamines and mono-, di- and tri-isopropanolamines; esters of phosphorous acid or of phosphoric acid with aliphatic alcohols having 1 to 6 C atoms, preferably ethyl phosphate, dimethyl phosphate, isopropyl phosphate, diisopropyl phosphate, butyl phosphite and dimethyl phosphite; and triazoles; preferably benztriazole and tolyltriazole.

U.S. Pat. No. 5,891,225 describes a corrosion inhibited de-icing composition comprising a halide brine containing a combination of a polyhydroxy carboxylate and a polyalkoxylated amine.

U.S. Pat. No. 5,849,356 describes a de-icing salt composition containing starch.

U.S. Pat. No. 6,905,639 B2 describes a fire retardant composition containing xanthan gum that are compatible with ammonium polyphosphate-based fire retardant compositions.

U.S. Pat. No. 4,650,589 describes a dust suppressing composition comprising: (a) 20-99.5%, by weight, water and (b) the balance a composition comprising at least one methacrylate polymer, at least one hydrophobic liquid, and at least one emulsifying surfactant.

U.S. Pat. No. 5,211,868 describes a de-icing composition containing a water-soluble dihydrogen orthophosphate, a water-soluble magnesium salt, and a de-icer salt.

U.S. Pat. No. 5,531,931 describes a de-icing composition comprising a de-icing salt and about 94.0 to about 99.5 weight percent, and preferably about 95.0 to 99.0 weight percent, deicing salt; and about 0.5 to 6.0 weight percent, and preferably about 1.0 to 5.0 weight percent, of a corrosion inhibitor selected from the group consisting of water-soluble rare earth salts and water-soluble organic acid salts.

U.S. Pat. No. 5,851,418 describes a granular composition for melting ice and inhibiting corrosion of metals and spalling of Portland Cement Concrete and asphalt comprising primarily a water soluble chloride salt, such as sodium chloride, or magnesium chloride; very small amounts of an oxygen scavenger such as sodium nitrite; a surface deactivating corrosion inhibitor such as sodium borate; and an in-situ formed water soluble phosphate salt such as ammonium phosphate amounting to between 1 and 10 percent exhibiting a property of chemically reacting with metal surfaces to form protective coatings.

U.S. Pat. No. 5,843,330 describes an anti-icing composition having anti-corrosion and anti-spalling properties including an anti-icing chemical selected from the group consisting of calcium chloride, sodium chloride, potassium chloride, magnesium chloride, urea, calcium magnesium acetate, calcium acetate, magnesium acetate, potassium acetate, sodium formate and combinations thereof, the anti-icing chemicals being at least 5% by weight of said anti-icing composition; an anti-corrosion compound being 2 butyne-1,4 diol in the range of trace amounts up to 5% by weight of the anti-icing composition; a water-soluble anti-spalling compound in the range of trace amounts up to 10% by weight of the anti-icing composition; and a diluent chemical, such as water, in the range of 10% to 80% by weight.

U.S. Pat. No. 5,595,679 describes corrosion inhibitors for use with road deicing compositions which lessen the typical corrosive properties on metal and/or concrete resulting from application of road deicers. The inhibitors include respective quantities of a citrate component such as citric acid, as well as a second silicate or metasilicate component, e.g., sodium metasilicate. The inhibitor compositions preferably include from about 0.5%-50% by weight of the citrate component and from about 50%-99.5% by weight of the second silicate component.

U.S. Pat. No. 5,302,307 describes a liquid deicing composition comprising MgCl₂ and an organic inhibitor selected from the group consisting of triethanolamine, triethanolamine acid salts, citric acid, metal salts of citric acid and mixtures thereof.

U.S. Pat. No. 5,135,674 describes a deicer composition containing a deicing compound plus between about 0.5 and about 5.0 weight percent of a gelling agent, such as hydroxyethyl cellulose, to minimize spalling of concrete to which the deicer composition is applied.

U.S. Pat. No. 5,127,954 describes a de-icing composition containing a corrosion inhibitor comprising at least one of the following: sodium fluorophosphate, and a water soluble salt of phosphonic acid derivatives.

U.S. Pat. No. 5,092,923 describes a de-icing composition containing inhibiting chloride-induced corrosion in reinforcing steel (rebar) present in concrete structures such as roadways, bridges, and buildings. A boron-containing compound, such as a borate salt, is applied to the reinforced concrete structure. Application can be done by applying a mixture of road salt and the boron-containing compound or by applying a solution having the boron-containing compound to the concrete structure.

U.S. Pat. No. 4,896,925 describes a process and composition for controlling ice and/or snow with reduced corrosion involves a mixture comprising an alkali metal salt; a lignosulfonate; and a corrosion reducing additive in the form of a salt of aluminum, antimony, cadium, cobalt, manganese, nickel, zinc, and combinations thereof.

U.S. Pat. No. 4,824,588 describes a deicing composition comprising saccharinic acid, lignosulfonate and an alkali metal or alkaline earth metal chloride selected from sodium chloride, magnesium chloride, calcium chloride and mixtures thereof, the ratio of said saccharinic acid, lignosulfonate and chloride being from about 0.05:0.95:15 to about 0.75:2.25:1. The composition has a pH value of from about 5.0 to 9.5.

U.S. Pat. No. 4,803,007 describes a deicing composition which comprises a solid mixture of sodium chloride and a corrosion inhibitor comprising a water-soluble divalent metal ion and an alkali metal polyphosphate selected from the group consisting of tripolyphosphate, pyrophosphate, hexametaphosphate and mixtures thereof.

There is a need, however, for a method for applying an environmentally acceptable, easy to use, aqueous halide dust control composition with reduced corrosion and without extensive metal corrosion or damage to contacting metal surfaces. There is a need in the art for a method of applying halide brines with improved corrosion-inhibition properties adapted for addition to otherwise conventional dust control compositions.

### SUMMARY

Accordingly, the present invention is directed to a method of inhibiting dust on a surface by applying an aqueous halide brine composition to said surface with limited corrosion, wherein the composition comprises a blend of one or more dissolved salts (halide brine), dissolved xanthan gum, and optionally containing glycerin.

The terms salt used in this invention includes its common meaning of sodium chloride as well as chemicals which are often substituted by highway maintenance departments for sodium chloride including calcium chloride, magnesium chloride, aluminum chloride, ammonium sulfate, calcium acetate, calcium magnesium acetate, ice phobic coatings, lithium chloride, magnesium acetate, potassium acetate, potassium carbonate, potassium bicarbonate, potassium chloride, potassium phosphate, sodium formate, sodium nitrate, sodium sulfate, South Dakota “X”, tetrapotassium pyrophosphate, and urea.

In one embodiment, there is disclosed a method of inhibiting dust by applying an aqueous composition from a diluted concentrate wherein the concentrate composition contains about 20 to about 80 wt. % glycerin, about 10 wt. % to about 70 wt. % salt; about 5% to about 10% xanthan gum; and about 5 wt. % to about 30 wt. % water. The concentrate composition is diluted with water prior to use to provide a dust-control composition containing about 0.1 wt. % to about 40 wt. % salt; about 10 wt. % to about 40 wt. % glycerin; about 0.01 wt. % to about 5.0 wt. % xanthan gum; and about 30 wt. % to about 50 wt. % water.

In a preferred method for applying halide brine to a surface with limited corrosion, the steps comprise: forming an admixture of xanthan gum solubilized in a halide brine solution in an amount effective to inhibit corrosion; and applying the admixture to a surface at a rate effective for dust control. The cation of the halide brine is preferably selected from the group consisting of calcium, magnesium, sodium, potassium, lithium, or a combination thereof. Preferably the solution comprises from about 0.1 to about 40 weight percent halide salt, preferably about 20 wt. % to about 40 wt. % salt, preferably calcium chloride; and 0.01 to about 5 wt. % xanthan gum, preferably about 0.1 to about 1% by weight xanthan gum; and about 30 wt. % to about 50 wt. % water.

In the preferred embodiment, the admixture is applied to a road surface for controlling dust. The rate of application during this dust control embodiment is from about 0.001 to about 5 gallons per square yard, preferably, 0.1 to about 1.5 gallons to 1 square yard. The admixture can be applied by sprinkling or using a spray nozzle.

During one preferred method described herein, the rate of corrosion of steel and aluminum by the admixture is reduced by at least 80%, preferably at least 85% as compared to the rate of corrosion of steel by a halide brine of the same concentration but without the xanthan gum. Surprisingly, when the xanthan gum is used as a corrosion inhibitor, the concentration of the xanthan gum need only be about 0.005% by weight of the dust control composition.

In a preferred glycerin-free composition of a corrosion inhibited calcium or magnesium chloride brine for use on road surfaces, the brine comprises from 0.1 to 1% xanthan gum and about 99 to about 99.9% aqueous halide brine solution containing about 5 wt. % to about 40 wt. % salt.

In another embodiment, the dust control composition can be provided as a concentrate, for subsequent dilution with water; comprising about 5 wt. % to about 30 wt. % water; about 5 wt. % to about 80 wt. % salt, preferably about 30 wt. % to about 50 wt. % salt; and about 3 wt. % to about 15 wt. % xanthan gum, preferably about 5 wt. % to about 10 wt. % xanthan gum.

In one method of applying halide brine for corrosion-inhibited dust control the steps comprise: forming an admixture of xanthan gum dispersed in a halide brine solution in an amount of xanthan gum that is effective to inhibit corrosion of metals; and applying the admixture to surfaces of dust-producing materials. In this preferred method, the cation of the halide brine is selected from the group consisting of calcium, magnesium, sodium, potassium, lithium, and a combination thereof. Preferably, the solution comprises from 0.1 to about 40 weight percent calcium chloride and/or magnesium chloride, more preferably about 0.5 wt. % to about 30 wt. % calcium and/or magnesium chloride.

### DETAILED DESCRIPTION

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The corrosive effect of halide brines on steel and other metals is limited by the method of applying a halide brine comprising a xanthan gum corrosion inhibitor. The surprising discovery in the method of this invention is the synergistic effect of improved corrosion-inhibiting properties resulting from the presence of xanthan gum applied to various surfaces. Any surface exposed to dust-producing conditions can benefit from the method described herein.

Typical surfaces that require treatment for exposure to dust-yielding conditions are roadways, pavements, paved and unpaved open areas such as stock yards, bridges and the like. Coal and other minerals may also produce dust that must be contained so as to limit pollution of the environment. Automobiles, metal rods used in construction of roads and bridges and the steel and metal components associated with the railways and other materials-handling equipment benefit from the corrosion-inhibiting feature of xanthan gum during treatments for dust control.

In the practice of this invention, calcium chloride is a preferred halide for use in the method of applying a halide brine/xanthan gum solution to various surfaces for dust control purposes. The chloride solution comprises a weight percentage of salt effective to achieve dust control. Users familiar with the art can determine more exact percentages of salt by the dust-producing conditions at the time of application. A preferred weight percent of salt is within a range of from 0.1 to 40 weight percent, more preferably about 5 wt. % to about 30 wt. % salt.

In general, sodium chloride is less effective than magnesium or calcium chloride for dust control. In dust control, magnesium and calcium chloride retain moisture better than sodium chloride, but it is generally thought that uninhibited calcium chloride is more corrosive than magnesium chloride. However, with the corrosion inhibiting admixture containing xanthan gum, the corrosion caused by calcium chloride brines is significantly limited, i.e. the rate of corrosion of steel with corrosion inhibitors is reduced by at least 80% as compared to the rate of corrosion inhibition in a sodium chloride brine of the same concentration but without xanthan gum.

The concentration of the salt in the brine solutions for dust control generally comprises from 0.1 to 40 weight percent, preferably about 1% to about 30% by weight.

The xanthan gum is soluble in the halide brine solutions and is easily mixed.

In the method of dust control and corrosion inhibition, the admixture resulting from the blend of xanthan gum in aqueous halide solution is applied to a surface of the material requiring dust control. One preferred rate of application is from about 0.001 to 5.0 gallons of admixture per square yard of surface treated. Rates vary according to the surface receiving the application. With unpaved roads, for example, the rate of application can be adjusted within a preferred range of 0.1 to 1.5 gallon of blend to one square yard of road. Treatment rates of application for other surfaces are known in the art.

The admixture can be applied to the surfaces of roads, bridges or bulk substances carried in open containers by any of several methods known in the art. One preferred method is sprinkling of the admixture solution over the surface requiring freeze conditioning or dust control. Another preferred method is spraying the admixture by nozzles, preferably pressurized nozzles, so that the mechanical action of the spray increases the penetration of the admixture into unpaved road surfaces, coal, coke, limestone, and the like. Other known methods can be used to apply the admixture.

What is claimed:

1. A method for controlling dust on a surface with limited corrosion comprising
forming an admixture of xanthan gum in a halide brine solution wherein the xanthan gum is present in an amount effective to inhibit corrosion of a contacting metal selected from the group consisting of iron and aluminum; and
applying the admixture to a surface in an amount effective for dust control.

2. The method of claim 1 wherein the cation of the halide brine is selected from the group consisting of calcium, magnesium, sodium, potassium, lithium, and combinations thereof.

3. The method of claim 1 wherein the solution comprises from 0.1 to about 50 weight percent of a salt selected from the group consisting of calcium chloride; magnesium chloride; sodium chloride; and mixtures thereof.

4. The method of claim 3 wherein the solution comprises from 0.1 to about 42 weight percent of a salt selected from the group consisting of calcium chloride; magnesium chloride; sodium chloride; and mixtures thereof.

5. The method of claim 4 wherein the solution comprises from 0.1 to about 35 weight percent of a salt selected from the group consisting of calcium chloride; magnesium chloride; sodium chloride; and mixtures thereof.

6. The method of claim 4 wherein the solution comprises from 0.5 to about 40 weight percent of a salt selected from the group consisting of calcium chloride; magnesium chloride; sodium chloride; and mixtures thereof.

7. The method of claim 3 wherein the halide brine comprises about 30 to about 50 weight percent of a salt selected from the group consisting of calcium chloride; magnesium chloride; sodium chloride; and mixtures thereof.

8. The method of claim 1 wherein the admixture is applied to the surface at the rate of from about 0.001 to about 5.0 gallon per square yard for controlling dust.

9. The method of claim 1 wherein the admixture is applied by sprinkling.

10. The method of claim 1 wherein the admixture is applied by spray nozzle.

11. The method of claim 1 wherein the rate of corrosion of steel by the admixture is reduced by at least 80 percent as compared to the rate of the corrosion of steel by the same concentration of the sodium chloride brine without xanthan gum.

12. A method for applying halide brine for corrosion-inhibited dust control comprising the steps of:
forming an admixture of xanthan gum dispersed in an halide brine solution in an amount effective to inhibit corrosion; and
applying the admixture to surfaces of dust-producing materials.

13. A composition suitable for dust control, while limiting corrosion iron containing metal surfaces contacted by said composition, consisting essentially of an aqueous halide brine solution containing at least about 10 wt. % salt and at least about 0.05% by weight xanthan gum.

14. An aqueous concentrate composition, suitable for dust control upon dilution with water consisting essentially of water; about 5 wt. % to about 80 wt. % salt; and about 3 wt. % to about 15 wt. % xanthan gum.

15. The aqueous concentrate composition of claim 14, containing about 30 wt. % to about 50 wt. % salt and about 5 wt. % to about 10 wt. % xanthan gum.

16. A method for controlling dust on a surface with limited corrosion comprising
forming an admixture of xanthan gum and about 20 wt % to about 80 wt. % glycerin in a halide brine solution wherein the xanthan gum is present in an amount effective to inhibit corrosion of a contacting metal selected from the group consisting of iron and aluminum; and
applying the admixture to a surface in an amount effective for dust control.

17. The method of claim 16 wherein the solution comprises from 0.1 to about 50 weight percent of a salt selected from the group consisting of calcium chloride; magnesium chloride; sodium chloride; and mixtures thereof.

18. The method of claim 17 wherein the solution comprises from 0.1 to about 42 weight percent of a salt selected from the group consisting of calcium chloride; magnesium chloride; sodium chloride; and mixtures thereof.

19. The method of claim 17 wherein the solution comprises from 0.5 to about 35 weight percent of a salt selected from the group consisting of calcium chloride; magnesium chloride; sodium chloride; and mixtures thereof.

20. The method of claim 16 wherein the halide brine comprises about 30 to about 50 weight percent of a salt selected from the group consisting of sodium chloride; sodium chloride; and mixtures thereof.
